(19) United States
(12) Patent Application Publication
(10) Pub. No.: US 2014/0231175 A1
(43) Pub. Date: Aug. 21, 2014

(54) SWIVEL LIFT

(71) Applicant: Peter A. Mueller, Gattikon (CH)

(72) Inventor: Peter A. Mueller, Gattikon (CH)

(21) Appl. No.: 14/131,774

(22) PCT Filed: Jun. 30, 2012
(86) PCT No.: PCT/CH2012/000148

§ 371 Date: Apr. 25, 2014

(30) Foreign Application Priority Data
Jun. 30, 2011 (CH) 1099/11
Mar. 14, 2012 (CH) 369/12

(51) Int. Cl. B66B 9/08

(52) U.S. Cl. CPC B66B 9/0853
USPC 187/200

(57) ABSTRACT

The invention relates to a swivel lift (1) with swivel arms (2) with a parallelogram function on which a bridge plate (30) or a walkable and drivable swivel arm floor (6) or positionally stable steps (42) is mounted on the lower swivel arm (2), and the swivel arms (2) hold the lifting plate (7) horizontally positionally stable by means of bearing(s) (18), can be moved as needed longitudinally electronically or by forced control, and a ramp (8) and/or a gate (9) is mounted on the lifting platform (19) in front of or behind the lifting plate (7), and the lifting movement is accomplished by means of an operating cylinder (3) with the support of a gas spring (4).

### TECHNICAL FIELD

The invention relates to a lifting platform in the form of a swivel lift on or in buildings with a swivel means which is used simultaneously as a supporting bottom part, and a platform that constantly remains horizontal is mounted on it according to the preamble of the first claim.

### PRIOR ART

Lifting platforms for lifting goods from a lower to a higher level or, conversely, to lower them from a higher level, are known and can be scissor lifts, adjustable ramps or vertical or inclined elevators. For people who have difficulty using stairs, special stair lifts are also known which, similarly to a chair lift, can travel even several floors along a staircase.

### DESCRIPTION OF THE INVENTION

The object of the invention is to mount a simple swivel lift with safety elements on or in a building that enables the quick and safe movement of goods or people without the need for a pit or support elements under the swivel lift, and use thereof is automated as needed, according to the preamble of the first claim.

The broad market of application for swivel lifts is narrowed down here, so that, besides goods and people, people are addressed here, for example, who have a physical shortcoming and can overcome a height difference from A to B quickly, comfortably and safely by means of a swivel lift, and operators of such a system have the certainty that it is a simple construction and offers maximum safety nonetheless, which minimizes the investment and maintenance costs, in addition to reducing indirect environmental costs, such as energy costs.

In private households, offices and businesses, height differences are encountered almost everywhere, most of which are overcome using steps or ramps. For wheelchair users, for example, ramps are usually a convenient solution provided that the angle is kept small and, depending on regional legislation, does not exceed 6° for unassisted use or 20° with assistance. Unfortunately, stairs cannot be ridden on, for which purpose there are aids such as stair lifts, which are technically intricate and can pose a challenge for the user as well.

The inventive solution in this regard is a lifting platform in the form of a swivel lift, wherein the swivel arms, which are embodied as parallelograms and between which the operating cylinders are advantageously mounted so that the swivel lift can be safely raised and lowered, the lower swivel arm segments being used simultaneously as a traversable floor segment, for example by having the lower swivel arms be part of the floor plate, thus enabling them to be manufactured cost-effectively. By virtue of the swivel arm construction, which constitutes a parallelogram, the lifting plate mounted in the rear can thus move at a constant angle, i.e., horizontally up and down.

If such a swivel lift is now raised to the upper level, a straight line is created at the end station, which is to say that the swivel arm floor and the lifting plate are at the same level, so that the person can exit the lifting platform horizontally.

To ensure that the procedure is safe, the lifting plate has lateral articulated guard railings, on one of which the operating buttons are arranged, or a gooseneck which carries the keypad, an access barrier being set up on the side facing away from the obstacle, or a gate, so that the person cannot fall out to the sides or to the rear. An additional guard rail on the upper level further improves safety.

The operating cylinder that is located between the swivel arms has end stop damping, so that the start and stop at the respective level occurs gently. A gas spring is additionally mounted with the operating cylinder whose purpose it is, in the event of a breakdown of the operating cylinder—which can be a hydraulic cylinder or an electro-cylinder with spindle drive—not to allow the lifting platform to simply fall downward, instead safely braking it and, in addition to the damping function, also has an spring load accumulator function, so that the operating cylinder need never exert the full lifting force because a portion of the force is supplied by the gasgas spring.

The gas spring can also perform a retaining function in the upper position, particularly by exerting a greater expulsion force than for maintaining the overall mechanics, including bearing the load of a person or goods. In the event of a breakdown of the hydraulics and complete loss of pressure in the unit, the swivel lift moves upwards.

If the operating cylinder is hydraulic, the button or lever has a Bowden cable that switches a corresponding valve on the hydraulic system manually to pressureless, so that, in the event of an electrical blackout in which the lifting platform happens to stop at an intermediate level, the lifting platform can be lowered again in at least a safe and cushioned manner. If the operating cylinder is electrical with spindle drive, and the spindle is not self-locking, it has an electrically detachable ratchet lock on the spindle or on a pivot bearing of the swivel arms, and the ratchet lock can also be manually unlocked by means of a Bowden cable, or the electrical operating cylinder is connected to a lockable gas spring that can also be released manually.

By means of the swivel arms, which normally only execute a partial lift range, the swivel area can be doubled—for example, the swivel arms are 160 cm long, and a lift range of 150 cm is covered—an upper level of up to 300 cm can be reached. Longer swivel arms increase the lift range of the lifting platform. In all cases, another advantage is that no floor cylinders or pits are required in order to operate such a lifting platform.

If the swivel lift does not execute the full range upward, a gap is left between the lifting plate and the floor in the upper floor. This gap can be overcome by means of an appropriate structural projection on the building, or the lifting plate has a separate, pivoted lifting plate that can only be lowered to horizontal, thus forming a bridge to the next-higher level.

In the case of large height differences, such as in industrial plants in which the swivel lift can be used as an intermediate floor for warehouse stock, for example, it is also conceivable for the lifting plate to move vertically upon swiveling of the swivel arms and not adopt the arc-shaped movement of the swivel arms by having the lifting plate be supported horizontally in a movable manner. For this purpose, the lifting plate presses by means of rollers with spring force against the wall of the building, or the lifting plate is guided by means of an appropriately shaped rod and can therefore perform any desired horizontal movement during the lifting process in addition to its vertical movement, or an operating cylinder moves the lifting plate horizontally in coordination with the lift height, controlled by a controller with an appropriate algorithm.

In emergencies, not only the hydraulic pressure or, by means of other measures, the swivel lift be lowered, but rather the swivel lift can also be functionally converted into a ramp by means of a tilting chassis and lock.

Instead of the ramp function, the swivel lift can have a step function through segmentation of the front floor plate, in which case the individual segments act as steps, thus forming positionally constant stairs by virtue of the parallelogram construction of the swivel lift.

As another overall safety element, the swivel arms are concealed with a covering means, so that no body part of a person or object can get between the swivel arms. Particularly in public facilities, the lifting platform can be equipped with an RFID or similar access means, so that authorized persons can use the swivel lift at any time without a key, or mothers with strollers can obtain a pass for a certain period of time in order to make use of these conveniences to overcome obstacles.

According to the invention, this is achieved by the features of the first claim.

The essence of the invention is to provide an extremely simple and effective swivel lift for persons and goods by means of a swivel arm floor that is part of a swivel arm and of a lifting platform 7, which remains positionally constant, said swivel lift being operated hydraulically or electrically and having a gas spring which supports the lifting force and simultaneously acts as a damping means and can also allow the Bowden cable to be safely lowered manually at any time by means of a Bowden cable, or it can be converted into a ramp using a switch, or it can have a stair function instead of a ramp function.

Additional advantageous embodiments of the invention follow from the sub-claims.

### BRIEF DESCRIPTION OF THE DRAWINGS

Exemplary embodiments of the invention will be explained in further detail below with reference to the drawings. Same elements are provided with the same reference symbols in the various figures.

FIG. 1 shows a schematic side view of a swivel lift in the lower position with the parallelogram consisting of two swivel arms and an operating cylinder and a gas spring and a positionally constant lifting plate with a rear-side gate, foldable ramp and an articulated guard rail on which the command buttons and an identification means are arranged;

FIG. 2 shows a schematic side view of a swivel lift in the upper end position with the parallelogram consisting of two swivel arms and an operating cylinder and a gas spring and a positionally constant lifting plate with a rear-side closed gate, foldable ramp and an articulated guard rail on which the command buttons are arranged and the possibility of doubling the lift range;

FIG. 3 shows a schematic side view of a swivel lift in the upper end position with the positionally constant lifting plate on which the parallelogram is attached, which consists of two swivel arms and an operating cylinder and a gas spring which engage on a guided carriage which is attached on an arm and is supported on the wall;

FIG. 4 shows a schematic side view of a swivel lift in the upper end position with the positionally constant lifting plate on which the parallelogram is attached, which consists of two swivel arms and a gas spring and an operating cylinder with pressureless switch on the hydraulic unit and pressureless lever on the console and the console is tiltable;

FIG. 5 shows a schematic side view of a swivel lift in the uppermost stopping position with the parallelogram consisting of two swivel arms and an operating cylinder and a positionally constant lifting plate, with a rear-side gate, foldable ramp and an articulated, extendible first guard rail and a bridge plate;

FIG. 6 shows a schematic side view of a swivel lift in the uppermost stopping position with the parallelogram consisting of two swivel arms and an operating cylinder and a gas spring and a horizontally movable, positionally constant lifting plate with support wheel, track guide, spring, foldable ramp and a guard rail and a guide rod with guiding means on the lifting plate, as well as lighting means arranged laterally on it;

FIG. 7 shows a schematic side view of a swivel lift in the uppermost stopping position with the parallelogram consisting of two swivel arms and a set of pivoted positionally constant steps and lifting plate.

Only the elements that are essential to directly understanding the invention are shown schematically.

### MANNER OF CARRYING OUT THE INVENTION

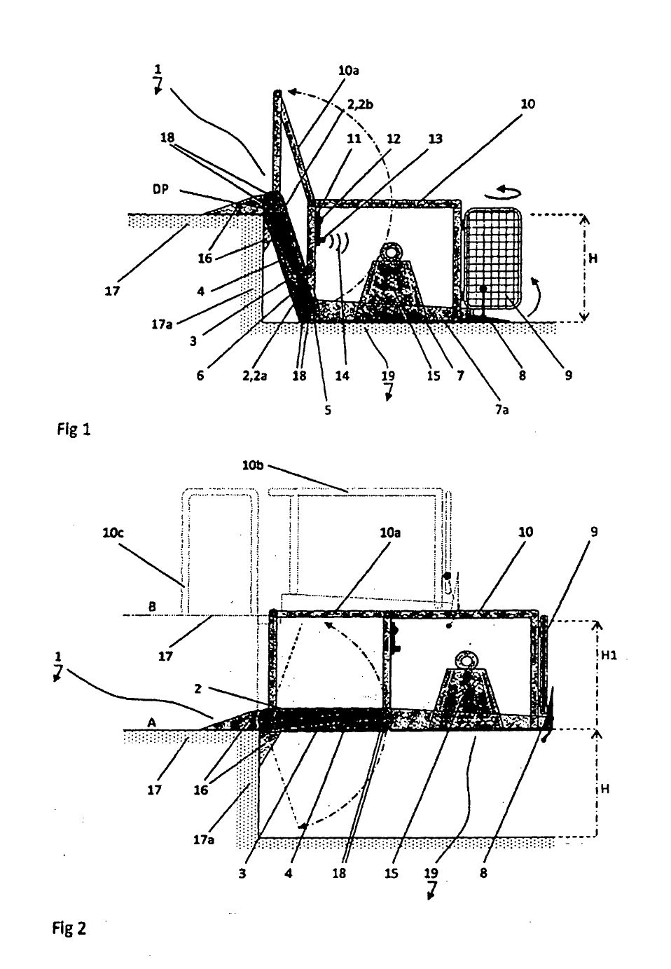

FIG. 1 shows a schematic side view of a swivel lift 1 in the lower position with the parallelogram consisting of two swivel arms 2 under which is located the swivel arm floor 6 and, connected to that, the positionally constant lifting plate 7 with the foldable ramp 8, which forced-controls the gate 9; in addition, an articulated guard rail 10 is mounted on the swivel lift that has a command button 11 consisting of a button 12, the pressureless lever 13 and an identification means 14 for recognizing the user, and an operating cylinder 3, a gas spring 4 and a covering 5 are located on the swivel lift 1.

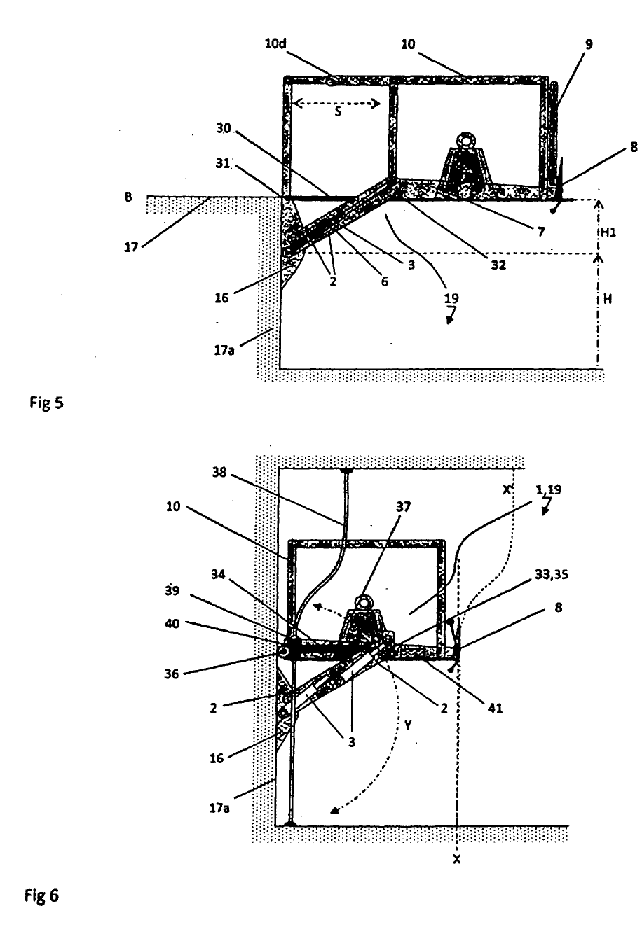

If a lifting means that [carries] goods, people or a person with a wheelchair, for example, shown here as the weight 15, is to be moved to a higher level, then a commensurately safe lifting means is needed which takes up little space on or in the building and does not require any elaborate technical alterations to the building's structure, such as a pit for the lift and burdensome pillars on the floor of the building, so that a console 16 is installed only on the upper level in order to mount the swivel lift 1 there. Depending on the structural design on the upper level, the console 16 is bolted on the floor 17 or against the wall 17a. The swivel arms 2 are pivoted on the console 16 and simultaneously connected to the lifting plate 7 by means of bearings 18, so that the swivel arms 2 form a parallelogram, thus keeping the lifting plate 7 positionally stable upon swiveling of the swivel arms 2. An operating cylinder 3 installed diagonally in the parallelogram is integrated with same in a space-saving manner and can use the same bearing elements or bearing bolts as the swivel arms 2 and also communicate with the attachment and bearing of the lifting plate 7. The same applies to the gas spring 4, which constitutes, on the one hand, a strength support for the operating cylinder 3, namely in that the gas spring 4 can just hold at least the weight of the lifting platform 19, consisting of the swivel arm floor 6 and the lifting plate 7, plus the inherent weight of the swivel arms 2, ramp 8, gate 9, guard rail 10 and other additions, and in that the gas spring 4 acts as a damper in the event that the operating cylinder 3 breaks down, and the lift stop can be raised manually using a Bowden cable 28 shown in FIG. 4, as a result of which the lifting platform 19 automatically lowers, braked only by the gas spring 4. The inclusion of the gas spring 4 also makes it possible to save electricity since, as a result of the support of the gas spring force, a smaller-diameter hydraulic operating cylinder is needed, which is to say less hydraulic oil needs to be pumped, thus reducing power consumption. The same applies to an electrical operating cylinder, which must perform the upward lift with lower wattage and requires less braking when traveling downward, thus resulting in energy savings.

The operating cylinder 3 can be a hydraulic cylinder with integrated end stop damping or an electro-cylinder with spindle drive with a controller (not shown here) which enables a soft start and soft stop by means of range measurement, such as by means of pulse width modulation. Moreover, the lift range H can be established by means of a locked gas spring 4, or the operating cylinder has pipe break protection or, in the event that the lifting platform 19 leaves its nominal position, the hydraulic unit is immediately activated from “sleep mode” by means of the controller and its lift range sensor, and the nominal value is reestablished. If the operating cylinder is an electro-cylinder with spindle drive and if it is not self-locking, then it can be realized by means of an electrically releasable ratchet lock with which the lift can be locked downward. If the spindle is self-locking, then one of the bolts that hold the operating cylinder diagonally in the parallelogram can be loosened to release the lift. Common to all of the operating cylinder designs is that they can be triggered manually by means of a Bowden cable 28, so that the lifting platform 19 can at least be lowered to the lower level in the event of a power outage.

A central element on the lifting platform 19 is the swivel arm floor 6, which can be part of the lower swivel arms 2a, inherently improves the stability and the synchronization of the operating cylinders 3 optionally mounted on both sides, and the lifting platform 19 also does not take up any additional space in the lower position. Another central element is that the swivel arm floor 6 simultaneously forms a traversable surface on the top level and can be flush with the upper level due to the pivot bearing DP and requires no gap-bridging means. In terms of production engineering, the lower swivel arm 2a is very easily created by bending the swivel arm floor 6 on both sides, thus already forming the swivel arm 2a, after which the bearings 18 need only be inserted. The lifting plate 7 connected to the swivel arm floor 6 can also be a bended sheet metal part; the side bolsters are used to accommodate the bearings 18 while simultaneously increasing the rigidity of the sheet metal and indicating the lateral limits of the lifting plate 7. In addition, a guard rail 10 can be mounted on the lifting plate 7, as well as an articulated guard rail 10a that is attached to the console 18. Mounted behind the lifting plate 7 is a spring-loaded foldable ramp 8 that folds up during raising of the lifting plate 7, thus preventing a wheelchair from rolling from or off of the lifting plate 7, or it also permits a gate 9 to swivel by 90° by means of an forced control, so that the entire rear part of the lifting plate 7 is closed. The forced control can be embodied such that the gate 9 cannot be opened manually, but only by folding down the ramp 8, which is connected, for example, by a self-locking worm gear and can thus easily be opened again.

Normally, lifts have two buttons 12: one for raising and one for lowering. One novel aspect here is that only one button 12 is required, since the controller recognizes the position of the lifting platform 19, i.e., whether it is parked at the top or bottom. If the lifting platform 19 is parked at the bottom and the button 12 is pressed, the information is sufficient for moving the lifting platform 19 upward. While going up, if it occurs to the user that they forgot something, for example, then they can press the button 12 again and the swivel lift 1 stops. Pressing it again then lowers the lifting platform 19. The positional recognition is done at the swivel arms 2 or in the form of a lift range measurement or in the operating cylinder 3.

Uniform codes for wheelchairs and strollers that can be used throughout Europe and on other continents as well are practical, particularly for public facilities, thus giving people everywhere authorization to use such a swivel lift 1. For example, an RFID is displayed which gives the user the free pass to use the swivel lift 1 at any time, and the same applies to mothers with strollers, who can obtain a permit through an official service for a certain period of time, which can be achieved by means of a chip in credit card format or as an app on a smartphone.

FIG. 2 shows a schematic side view of a swivel lift 1 in the upper end position with the parallelogram consisting of two swivel arms 2 under which the swivel arm floor 6 is located and, connected to that, the positionally constant lifting plate 7 with the foldable ramp 8 which forced-controls the gate 9, and an articulated guard rail 10 is also mounted on the swivel lift which has a command button 11 on it, consisting of a button 12, the pressureless lever 13, and an operating cylinder 3, a gas spring 4 and a covering 5 are located on the swivel lift 1 with the possibility of doubling the lift range.

Once the lifting platform 19 has reached the upper level A, the swivel arm floor 6 is fully traversable; the articulated guard rail 10a also extends horizontally and can be used as a hand rail.

The kinematics of the swivel arms 2 and the diagonal placement of the operating cylinder 3 and of the gas spring 4 enable the lift range H to effortlessly be doubled by the lift range H1, and the level B reached, which has its own guard rail 10c, and the lifting platform 19 has a modified guard rail 10b, so that the user's safety continues to be absolutely ensured. If the lifting platform 19 is used for traveling to level B, another gate 8 with ramp 8 is arranged on the front side of the lifting plate 7 as a safety measure which also opens by forced control as soon as the ramp 8 contacts the upper floor 17.

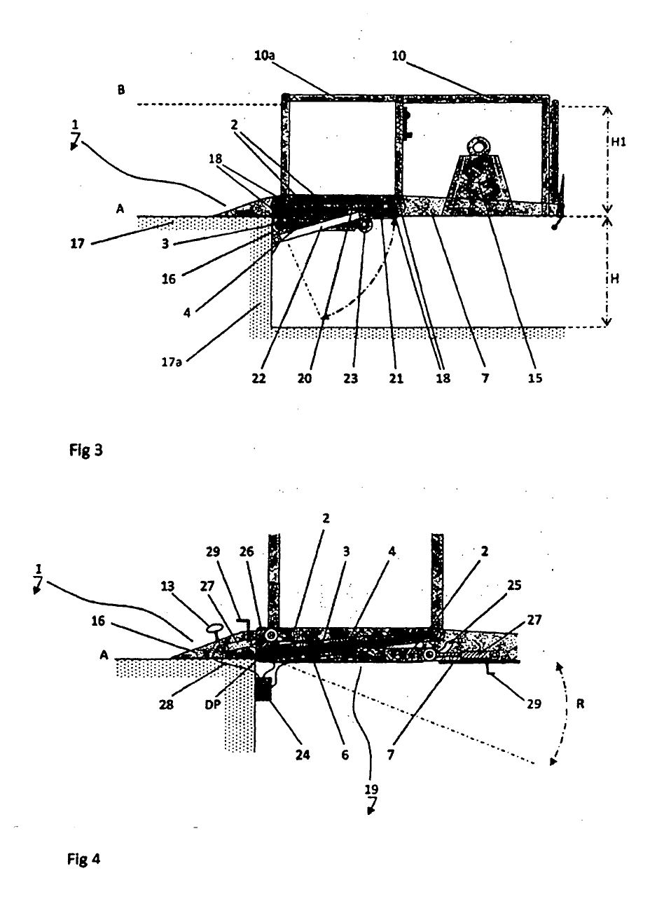

FIG. 3 shows a schematic view of a swivel lift 1 in the upper end position with the positionally constant lifting platform 19 to which the parallelogram is attached, which consists of two swivel arms 2 and have an operating cylinder 3 and a gas spring 4 which engage on a guided carriage 20 that can be moved longitudinally in a track 21 and is attached to a lever 22 and is supported on the wall 17a.

For small, cost-effective systems, the swivel lift 1 can be actuated, for example, with only one operating cylinder 3 by mounting the operating cylinder 3 in the middle of and below the swivel arm floor 6. A track is arranged on both sides of the lower swivel arm 2, in which track 21 a carriage 20 is guided, a lever 22 being pivoted-mounted on said carriage 20 that is supported against the wall 17a. The carriages 21 arranged on both sides are connected to each other by a synchronous rod 23, and the operating cylinder 3 is articulated on that. In this case, the operating cylinder 3 is also pivoted on the wall 17a or on the console 16.

To lower the lifting platform 19, the plunger rod of the operating cylinder 3 comes out; as a result, the carriage 20 moves away from the wall 17a, and the swivel arm 2 lowers as a result of the longitudinally rigid lever 22, which can only tilt. As a result of the parallelogram function of the two swivel arms 2, the lifting plate 7 remains in the horizontal position. The gas spring 4 can be arranged parallel to the operating cylinder 3 or, as shown in FIGS. 1, 2, be attached diagonally between the swivel arms 2.

FIG. 4 shows a schematic side view of a portion of a swivel lift 1 in the upper end position with the positionally constant lifting plate 7 on which the parallelogram is attached, which consists of two swivel arms 2 and a gas spring 4 and an operating cylinder 3 with pressureless switch of a valve on the hydraulic unit 24 and pressureless lever 13 on the console 16, and the console 16 is tiltable by means of the tilt chassis 26, which can be held in position by a lockable small gas spring 27.

In order to overcome an upward obstacle, the swivel lift 1 as shown in FIGS. 1-3 is an optimum solution. Likewise, it is a most elegant and comfortable way to travel in the opposite direction as well, from above to below. In emergency situations, however, it would be better if it were possible to use such a swivel lift 1 as a ramp that could convey people or even goods quickly from above to below.

This is achieved, in the event that the lifting platform 19 is at the bottom, by pulling on the pressureless lever 13, which constitutes an emergency means for opening a hydraulic valve (not shown here) by means of the Bowden cable 28, which releases the retained pressure in the operating cylinder 3, upon which the hydraulic oil flows into the tank as soon as the piston rod of the operating cylinder 3 moves as a result of the gas spring 4, which presses the lifting platform 19 upward until it has arrived at the level A. After that, the pressureless lever 13 is released and the small gas spring 27, which is attached to the console 16 and to the tilt chassis 26, is released by means of the release lever 29. As a result, the lifting platform 19 tilts downward according to the arrow R at the point of rotation DP and finally constitutes a ramp. Instead of a small gas spring 27, a release hook with a clinker function, or a releasing means 25 and a damper can perform the same task.

Since the operating cylinder 3 is locked again as a result of the releasing of the pressureless lever 13, which is to say the hydraulic oil on the interior of the cylinder is restrained again, so the swivel arm floor 6 cannot buckle with respect to the lifting plate 7, resulting in a stable ramp that can therefore be used by other people as well in emergencies, e.g., during power outages.

FIG. 5 shows a schematic side view of a swivel lift 1 in the uppermost stopping position with the parallelogram consisting of two swivel arms 2 and an operating cylinder 3 and a positionally constant lifting plate 7, with a rear-side gate 9, foldable ramp 8 and an articulated, extendible first guard rail 10d and a bridge plate 30.

Normally, the lower swivel arm 2a is part of the swivel arm floor 6 and acts until the swivel arms 2 are in the horizontal position, which is at the level of the floor 17. If the lifting platform 19 continues upward into a higher floor, or if the point of rotation of the swivel arms 2 on the console 16 cannot be attached up to the level of the edge 31, then a gap S may occur between the edge 31 and the front side of the swivel arm floor 6. By means of the traversing plate 30, which is pivoted by means of the bridge bearing 32 laterally on the swivel arm floor 6 and travels along with the tilting movement of the traversing plate 30 from the lower stop position up to the horizontal position, indicated by the lift range H, becomes an independent element from this point forward which enables people and goods, at the uppermost stopping position of the swivel lift 1, to reach the upper floor 7, indicated by the lift range H, from the lifting plate 7 via the traversing plate 30. In this position, the swivel arm floor 6 no longer constitutes a traversing surface.

FIG. 6 shows a schematic side view of a swivel lift 1 in the uppermost stopping position with the parallelogram consisting of two swivel arms 2 and an operating cylinder 3 and a horizontally movable, positionally constant lifting plate 7 with counter-console 33, track guide 34, console carriage 35, supporting wheel 36, spring 37, with a foldable ramp 8 and a guard rail 10, as well as a guide rod 38 with guiding means 39 on the lifting plate 7, as well as workplace lighting 41.

Under very heavy loads, tight spatial situations or the need to drive around fixed objects, the lifting platform 19 can do without the swivel arm floor 6 and make use of that free space for the horizontal movement of the lifting plate 7. As described previously, with a lift range H,H1, the parallelogram describes an arc Y and, accordingly, the lifting plate 7 follows this arc shape. If that is not desirable, a counter-console 33 is mounted at the end of the two swivel arms 2 that has a console carriage 35. This carries and now guides the lifting plate 7, which has a track guide 34 and cooperates with the console carriage 35, so that the lifting plate 7 can move horizontally over the length of the track guide 34 with little friction. Three variants are possible for controlling the position of the lifting plate 7: In the first one, the lifting plate 7 presses with the front element 40 against a spring 37 that is supported on the counter-console 33, so that the lifting plate 7 leans against the wall 17a. To keep the lifting platform 19 operational, a supporting wheel 36 is mounted on the front element 40, so that the lifting plate 7 is pressed against the wall 17a upon swiveling of the swivel arms 2 around the lift range H, H1. It is elegantly received and moved away by the supporting wheel 36. The lifting plate 7 therefore moves along the line X, even though the parallelogram and the counter-console 33 follow an arc Y.

In the second variant, a guiding means 39 is attached to the lifting plate 7 by means of a guide rod 38 that is fixed to the wall 17a or to the ceiling or floor 17, so that the lifting plate 7 is always maintained at the position of the guide rod 38. Using the guide rod 38, it is also possible to travel around an immovable obstacle by forming an appropriate arc in the guide rod 38 and, since the lifting plate 7 is connected to the guiding means 39, the lifting plate 7 cooperates in the bypass in that it is moved horizontally by means of the track guide 34 and the console carriage 35 by forced control, according to line X′. The guiding means 39 can also be a pair of rollers or a simple loop or the like on the lifting plate 7.

In the third variant, a horizontal cylinder, which is attached, for example, to the front element 40 and the lifting plate 7, guides the lifting plate 7 horizontally away from or toward the wall as needed. This can be detected by means of a controller (not shown here) and the recognition of the lift position as an angular position of the swivel arm 2 or position of extension of the operating cylinder 3, compensated for using the algorithm in the controller and controlled accordingly.

If the swivel lift 1 is used as a space-creator by raising the lifting platform 19 over 2.4 m, for example, people can move underneath it without compromise, or a workspace can be set up with the lifting platform 19 above it for stowing rarely-used parts or cumbersome goods, for example, or it can be used for archiving and [provided] with workplace lighting 41 and other technical means as needed.

For reasons of protection, and due to the sleek construction, no projecting hydraulic elements or operating cylinder elements are desired. This is realized by means of two or more sleek operating cylinders 3 arranged in series on the parallelogram, such as, for example, a hydraulic operating cylinder 3 and, after that, a gas spring 4. In this way, the system remains sleek, and the components can also be covered quite well visually.

As in all of the figures described above, the swivel arms 2 are present in a dual design, which is to say a parallelogram is located both on the left and right of the respective lifting plate 7.

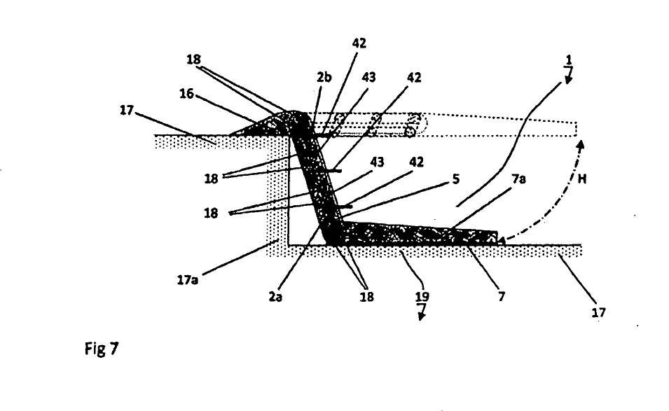

FIG. 7 shows a schematic side view of a swivel lift 1 in the uppermost stopping position with the parallelogram consisting of two swivel arms 2 and a set of pivoted positionally constant steps 42 and the lifting plate 7.

In general, a ramp works comfortably for moving goods only in one direction, namely downward. For people, ramps, particularly steep ones, are not recommended, and climbing upward is quite out of the question. Due to the basic configuration of the swivel lift 1 with its parallelogram, the swivel arm floor 6 is segmented into step sections which serve as steps 42. To keep them positionally constant, a connector 43 is arranged on the respective step 42 that is pivoted on the upper swivel arm 2b and on the lower swivel arm 2a by means of the bearing 18. If the swivel lift 1 is parked in the upper position, the lifting plate 7 is positionally constant due to the pivoted connection to the upper swivel arms 2b and the lower swivel arms 2a. Such a connection is easy to produce in terms of its production engineering by bending the edges over, thus forming side bolsters 7a in which the bearings 18 are embedded. The lifting plate 7 therefore constitutes a virtual part of the lower floor 17, and the segmented swivel arm floor 6 serves as positionally stable steps 42 and can therefore be comfortably used by people in both directions. If the swivel lift 1 is used by a person with limited mobility, the steps 42 finally form an easy-to-walk-on surface in the upper position.

It is not shown that the steps 42 can be automatically released, e.g., by means of spring-induced catches, as soon as an object becomes wedged between the steps 42. As needed, the lifting movement of the lift range H, which is performed by the operating cylinders 3 (not shown here), can also be stopped by having a sensor working on the respective steps 42, or by arranging a TOF camera that alerts the controller, which then outputs the command to stop the lift range H.

As will readily be understood, the invention is not limited only to the exemplary embodiments shown and described.

### LIST OF REFERENCE SYMBOLS

1 swivel lift
2 swivel arm
2a lower swivel arm
2b upper swivel arm
3 operating cylinder
4 gas spring
5 covering
6 swivel arm floor
7 lifting plate
7a side bolster
8 ramp
9 gate
10a,b,c,d guard rail
11 command button
12 button
13 pressureless lever
14 identification means
15 weight
16 console
17 floor
17a wall
18 bearing
19 lifting platform
20 carriage
21 track
22 lever
23 synchronous rod
24 hydraulic assembly
25 releasing means
26 tilt chassis
27 small gas spring
28 Bowden cable
29 release lever
30 bridge plate
31 edge
32 bridge bearing
33 counter-console
34 track guide
35 console carriage
36 supporting wheel
37 spring
38 guide rod
39 guiding means
40 front element
41 workplace lighting
42 step
43 connector
S gap
Y radian
X vertical line
R ramp range
DP point of rotation
H1, H2 lift range

1. Swivel lift (1),
characterized in that a console (16) is attached to the floor (17) and/or to the wall (17a) on which the swivel arms (2) are mounted in a pivoted and overlapping manner as a parallelogram, and a swivel arm floor (6) is mounted under a swivel arm (2), and the swivel arms (2) or a swivel arm (2), together with the swivel arm floor (6), hold the lifting plate (7) horizontally positionally stable by means of bearing(s) (18), and an operating cylinder (3) and/or a gas spring (4) is articulated diagonally or transversely between the swivel arms (2), or a track (21) is mounted on a swivel arm (2) in which a carriage (20) engages, and the carriage (20) is fixed to a lever (22) and/or to an operating cylinder (3) and/or a gas spring (4) and/or synchronous rod (23), and the lever (22) and the operating cylinder (3) and/or the gas spring (4) are supported on the wall (17a) or console (16) and/or
the bridge plate 30 is arranged instead of the swivel arm floor (6), and/or
that the lifting plate (7) can be moved horizontally by means of a counter-console (33), track guide (34), console carriage (35) and can slide vertically along the wall (17a) by means of spring (37) and supporting wheel (36) or can move around fixed obstacles by means of a guide rod (38) and guiding means (39) or horizontal operating cylinder with controller, or
steps 42 are pivoted on the lower swivel arm (2a) by means of connectors (43) to the upper swivel arm (2b), and each of the steps (43) has an automatically releasable wedge protection.

2. Swivel lift (1) as set forth in claim 1,
characterized in that the synchronous rod (23) is connected to the operating cylinder (3) and/or gas spring (4) and lever (22).

3. Swivel lift (1) as set forth in claim 1,
characterized in that the swivel arm floor (6) is part of the swivel arm (2) and can be traversed.

4. Swivel lift (1) as set forth in claim 1,
characterized in that the swivel arm (2) are mounted on both sides of the lifting platform (19) and they are concealed by means of the covering (5).

5. Swivel lift (1) as set forth in claim 1,
characterized in that the operating cylinder (3) is a hydraulic cylinder or electro-cylinder and has a fluid or a pulse width-modulated end stop damping and/or a distance meter, or the swivel arm (2) has an angular sensor.

6. Swivel lift (1) as set forth in claim 1,
characterized in that the gas spring (4) is integrated next to or in the operating cylinder (3) and has the function of a spring load accumulator and damper.

7. Swivel lift (1) as set forth in claim 1,
characterized in that a guard rail (10, 10a, 10b) is mounted on the lifting platform (19).

8. Swivel lift (1) as set forth in claim 1,
characterized in that a ramp (8) and/or a gate (9) is mounted at the end and/or in front of the lifting plate (7), and the gate (9) is actively connected to the ramp (8).

9. Swivel lift (1) as set forth in claim 1,
characterized in that a single button (12) is mounted on the command button (11) which is responsible for moving up and down and stopping.

10. Swivel lift (1) as set forth in claim 1,
characterized in that a pressureless lever (13) is mounted on the swivel lift (1) that switches the operating cylinder (3) in a mechanically pressureless manner or releases a bolt or a ratchet lock.

11. Swivel lift (1) as set forth in claim 1,
characterized in that a tilt chassis (26) is mounted on the console (16), and the swivel lift (1) is functionally converted into a ramp by means of the release lever (29) and/or a small gas spring (28) or by means of releasing means (25) between swivel arm floor (6) and lifting plate (7) and/or damping means.

12. Swivel lift (1) as set forth in claim 1,
characterized in that the swivel angle of the swivel arms (2) reaches over 90°.

13. Swivel lift (1) as set forth in claim 1,
characterized in that workplace lighting (41) and several technical covering means can be arranged on the lifting plate (7).
